(19) United States
(12) Patent Application Publication
(10) Pub. No.: US 2012/0086609 A1
(43) Pub. Date: Apr. 12, 2012

(54) WIRELESS COMMUNICATION TERMINAL

(75) Inventors: Hironori Kikuchi, Miyagi (JP); Kenichi Sato, Miyagi (JP); Daigo Imano, Miyagi (JP); Yasunori Komukai, Miyagi (JP); Hiroaki Ohmori, Miyagi (JP)

(73) Assignee: PANASONIC CORPORATION, Osaka (JP)

(21) Appl. No.: 13/258,966

(22) PCT Filed: Dec. 3, 2010
(86) PCT No.: PCT/JP2010/007069

§ 371 Date: Sep. 22, 2011

(30) Foreign Application Priority Data
Dec. 4, 2009 (JP) 2009-276293

(51) Int. Cl. H01Q 1/24

(52) U.S. Cl. 343/702

(57) ABSTRACT

There is provided a wireless communication terminal that can accept plural wireless systems different in operating frequency by one antenna element. An antenna element 1 and a second conductive element 33 are connected to each other through a first blocking part 22 that blocks a second frequency band, the antenna element 1 and a first conductive element 23 are connected to each other through a second blocking part 32 that blocks a first frequency band, and the first wireless circuit 21 and the second wireless circuit 31 are arranged on boards different in potential to improve an isolation performance between the plural wireless systems, thereby enabling an excellent antenna performance to be obtained.

### TECHNICAL FIELD

The present invention relates to a wireless communication terminal such as a cellular phone or a PHS (personal handy-phone system).

### BACKGROUND ART

The wireless communication terminals such as the cellular phone or the PHS are required to accept a plurality of wireless systems different in operating frequency whereas an antenna element is mainly incorporated into the wireless communication terminal for thinning and downsizing. From the above viewpoints, an antenna element responding to a plurality of operating frequencies needs to be disposed within a limited space. Hence, when a plurality of antenna elements is arranged, the respective antenna elements are spatially electromagnetically coupled with each other to deteriorate the antenna performance.

In order to avoid the deterioration caused by the electromagnetic coupling, for example, Patent Document 1 discloses a technique in which “a distance between the antenna elements are made long to improve an isolation performance between the antenna elements. As illustrated in FIG. 12, a first antenna element 71 and a second antenna element 72 are arranged at a distance from each other even if housings are closed or opened, with the results that the isolation performance between the antenna elements is improved to suppress the deterioration of the antenna performance.

Also, in addition to the above example, for example, Patent Document 2 discloses a technique “that accepts the plurality of wireless systems different in the operating frequency, and forms a slit between antenna feeders for avoiding the electromagnetic coupling between the antenna elements to improve the isolation performance”. As illustrated in FIGS. 13(a) to 13(c), a slit is formed between a first feeder part 84 of a first antenna element 81 and a second feeder part 85 of a second antenna element 82 to suppress a current flowing in between the respective feeders, improve the isolation performance, and suppress the deterioration of the antenna performance.

Also, in order to avoid the deterioration of coupling, when one antenna element accepts the plurality of wireless systems different in the operating frequency, there is a need to provide a broadband antenna element.

In order to provide the broadband antenna, for example, Patent Document 3 discloses a technique in which “a power is fed from each end of one antenna element to switch a matching circuit”. As illustrated in FIG. 14, a feeder part and a matching circuit are disposed at each terminal of an antenna element 91, and the connection of the element is switched by a bandwidth changeover switch 92 to accept the plurality of wireless systems different in the operating frequency.

### PRIOR ART DOCUMENTS

### Patent Documents

Patent Document 1: JP-A 2005-277703

Patent Document 2: JP-A-2004-244317

Patent Document 3: JP-A-2006-310995

### SUMMARY OF THE INVENTION

### Problem to be Solved by the Invention

However, when the plurality of wireless systems different in the operating frequency operates at the same time, there arises such a problem that an excellent antenna performance cannot be obtained. For example, when the respective antenna elements are provided for a first wireless system and a second wireless system, a space in which the antenna elements can be arranged is limited because the wireless communication terminal is more downsized and thinned, and the higher density is caused by higher function. Therefore, those antenna elements cannot be arranged sufficiently at a distance from each other to deteriorate the isolation performance, resulting in the deterioration of the antenna performance due to the electromagnetic coupling effect between the antenna elements. Also, when the antenna elements are close to each other, the slit is formed between the feeder parts to prevent a current from flowing in therebetween, as a result of which the isolation performance can be improved. However, pattern lines and implemented parts are concentrated on an actual board, thereby making it difficult to ideally form the slit. This leads to a reduction in the implemented area, an increase in the costs, and an increase in the board size, thus affecting the terminal size.

In order to solve the above problem, if one antenna element accepts the first wireless system and the second wireless system, the electromagnetic couple effect can be removed. However, in order that the one antenna element accepts a plurality of frequencies, there is a need to provide a wideband antenna element. Under the circumstances, in order to accept the operating frequencies of the respective wireless systems, a matching circuit having a resonance frequency of the antenna element as the respective wireless operating frequencies is disposed at each end of the antenna element, and the connection of a wireless part can be switched. However, the operation of those wireless systems cannot be conducted at the same time.

An object of the present invention is to provide a wireless communication terminal in which one antenna element is connected with a plurality of wireless systems different in the operating frequency, the plurality of wireless systems can operate at the same time, and the antenna performance is excellent.

To achieve the above objection, there is provided a wireless communication terminal having a plurality of wireless systems different in operating frequencies, and having a hinge part which rotatably couples a first housing with a second housing, the wireless communication terminal comprising: a first wireless circuit having a first frequency band as the operating frequency; a second wireless circuit having a second frequency band different from the first frequency band as the operating frequency; a first circuit board disposed in the first housing and having the first wireless circuit mounted therein; a second circuit board disposed in the second housing and having the second wireless circuit mounted therein; an inter-board connection line that connects the first circuit board and the second circuit board for control the first circuit board and the second circuit board; an antenna element disposed at a given distance from the first circuit board; a first connection part electrically connected to the antenna element; a second connection part electrically connected to the antenna element at a position different from that of the first connection part; a first conductive element electrically connected to the first connection part; a first blocking part electrically connected to the first conductive element and the first wireless circuit, disposed on the first circuit board, and blocks the second frequency band; a second conductive element electrically connected to the second connection part; and a second blocking part electrically connected to the second conductive element and the second wireless circuit, disposed on the second circuit board, and blocks the second frequency band.

### Means for Solving the Problem

According to the above configuration, the electromagnetic coupling deterioration caused by disposing the plurality of antenna elements close to each other is reduced, a power is fed to one antenna element from the plurality of wireless systems different in the operating frequency mounted on the first circuit board and the second circuit board configuring the wireless communication terminal to prevent a current from flowing in between the feeder parts through the GND pattern on the same board, thereby enabling the isolation performance between the wireless systems to be improved. In the above configuration, because the GND patterns of the two circuit boards are connected by an inter-board connection line (a GND line for a thin control line in a DC manner), the potential is the same. However, in a high frequency manner, because of only the connection with the thin GND line, the potential is not the same, and the GND patterns can be dealt with as the boards different in the potential.

In the above configuration, the first connection part and the second connection part which are electrically connected to the antenna element are formed at both ends of the antenna element in a longitudinal direction of the antenna element.

According to the above configuration, the feed current is prevented from flowing through the GND patterns arranged on the same board. In addition, the high frequency current is allowed to flow in the antenna element in only a desired frequency band used by the respective wireless systems, and in other frequency bands, a current can be prevented from flowing into the respective wireless systems through the antenna element.

In the above configuration, a GND pattern provided on the first circuit board and a GND pattern provided on the second circuit board are configured at positions that do not overlap with each other when the housings are closed.

According to the above configuration, the current is prevented from flowing through the GND patterns arranged on the same board. In addition, when the housing is closed, the GND pattern on the first circuit board and the GND pattern on the second circuit board come close to each other, and are connected to each other in a high frequency manner with a capacitance provided therebetween. This enables the deterioration of the isolation performance caused by the electromagnetic coupling to be suppressed. Accordingly, even when the housing is closed, the isolation performance can be improved.

In the above configuration, the first blocking part provided in the first circuit board and the second blocking part provided in the second circuit board are configured on surfaces that do not overlap with each other when the housings are closed.

According to the above configuration, the respective blocking parts on which the current flowing from the antenna element is concentrated come close to each other on a plane. As a result, like the GND pattern, the respective blocking parts are connected to each other in a high frequency manner with a capacitance provided therebetween, and the deterioration of the isolation performance caused by the electromagnetic coupling is suppressed, thereby enabling the isolation performance to be improved.

In the above configuration, the hinge part is configured by the antenna element.

According to the above configuration, the existing hinge part can be used as the antenna element, and there is no need to newly provide the antenna element, and the terminal can be further downsized and thinned.

### Advantages of the Invention

According to the present invention, the wireless communication terminal can accept the plurality of wireless systems different in the operating frequency by one antenna element, and those wireless systems can operate at the same time. Therefore, the wireless communication terminal that accepts the plurality of wireless systems can be downsized and thinned.

### BRIEF DESCRIPTION OF THE DRAWINGS

FIGS. 1(a) and 1(b) are diagrams for illustrating an outline configuration of a wireless communication terminal according to an embodiment of the present invention.

FIG. 2 is a block diagram illustrating an outline configuration of the wireless communication terminal according to the embodiment of the present invention.

FIG. 3 is a block diagram illustrating an antenna element of the wireless communication terminal according to the embodiment of the present invention.

FIGS. 4(a) and 4(b) are diagrams for illustrating a first conductive element of the wireless communication terminal according to the embodiment of the present invention.

FIG. 5 is a diagram for illustrating a first blocking part of the wireless communication terminal according to the embodiment of the present invention.

FIGS. 6(a) and 4(b) are diagrams for illustrating a second conductive element of the wireless communication terminal according to the embodiment of the present invention.

FIG. 7 is a diagram for illustrating a second blocking part of the wireless communication terminal according to the embodiment of the present invention.

FIGS. 8(a) and 8(b) are schematic diagrams of operating states of a first frequency band and a second frequency band in the wireless communication terminal according to the embodiment of the present invention.

FIGS. 9(a) and 9(b) are schematic diagrams of a configuration in which the wireless communication terminal is closed according to the embodiment of the present invention.

FIG. 10 is a schematic diagram illustrating overlap of boards when the wireless communication terminal is closed according to the embodiment of the present invention.

FIG. 11 is a schematic diagram illustrating a configuration in which a hinge part is formed of an antenna element in the wireless communication terminal is closed according to the embodiment of the present invention.

FIG. 12 illustrates an overview of a conventional wireless communication terminal in which antenna elements are disposed at a distance from each other for the purpose of improving an isolation performance.

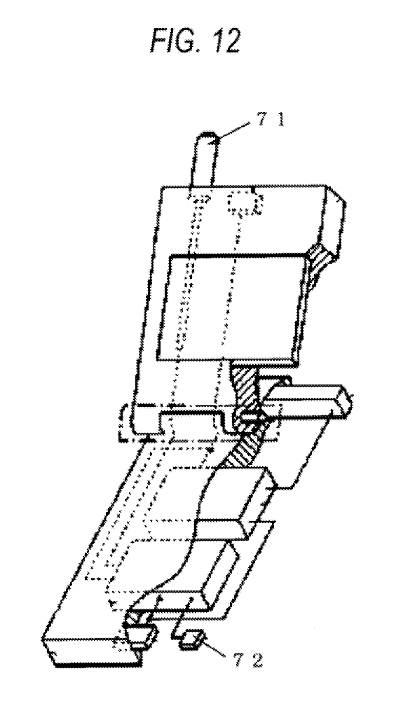

FIGS. 13(a) to 13(c) are diagrams illustrating an overview of a conventional wireless communication terminal providing wideband by one element.

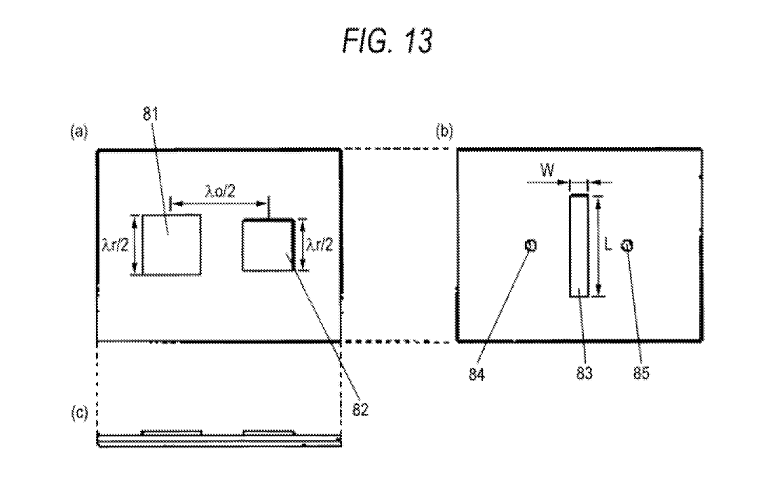

FIG. 14 is a diagram illustrating an overview of a conventional wireless communication terminal in which a slit is formed between antenna feeders for the purpose of improving the isolation performance.

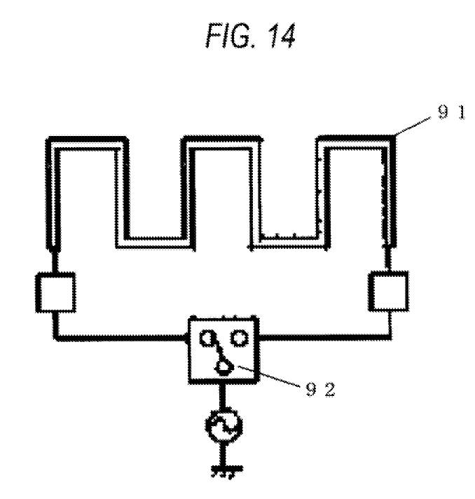

### MODE FOR CARRYING OUT THE INVENTION

Hereinafter, a preferred embodiment for implementing the present invention will be described in detail with reference to the drawings.

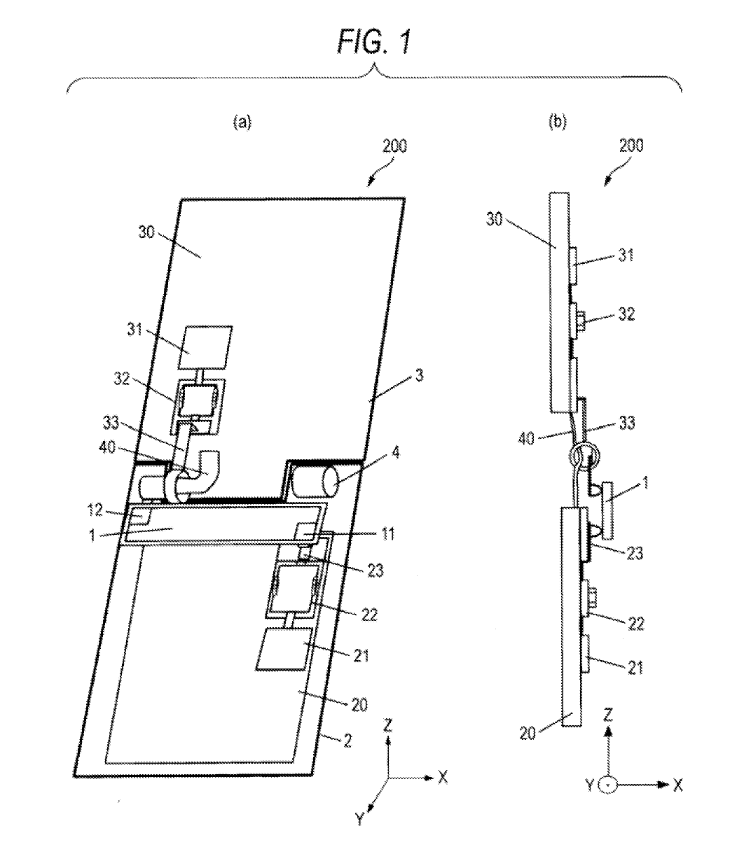

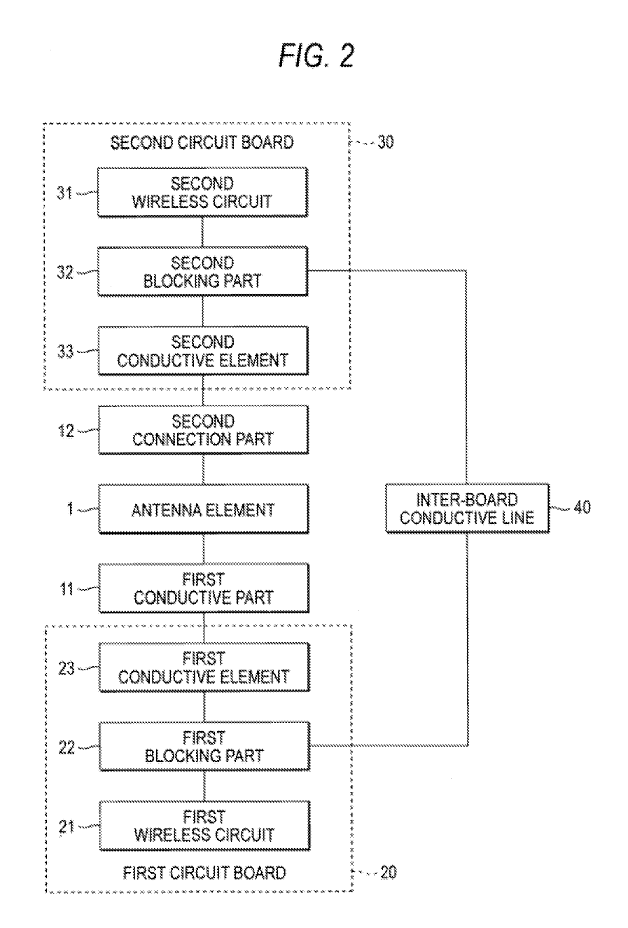

FIGS. 1(a) and 1(b) are configuration diagrams of a wireless communication terminal 200 according to an embodiment of the present invention. FIG. 1(a) is a perspective view, and FIG. 1(b) is a side view. Also, FIG. 2 is a block diagram of the wireless communication terminal 200 according to this embodiment.

Referring to FIGS. 1(a), 1(b), and 2, the wireless communication terminal 200 according to this embodiment includes an antenna element 1 and a first circuit board 20 which are disposed within a first housing 2, a second circuit board 30 which is disposed within a second housing 3, and a hinge part 4 that rotatably couples the first housing 2 and the second housing 3 with each other.

The antenna element 1 is disposed at a given distance from the first circuit board 20. Also, a first connection part 11 is electrically connected to one end of the antenna element 1, and a second connection part 12 is connected to the other end of the antenna element 1 at a side different from that of the first connection part 11. In the example, the given distance is directed to 2 mm or larger, and if the distance is larger, a radiation resistance is more increased to improve an antenna performance.

A first wireless circuit 21 having a first frequency band as an operating frequency, and a first blocking part 22 that is electrically connected to the first wireless circuit 21 are disposed on the first circuit board 20.

A second wireless circuit 31 having a second frequency band as the operating frequency, and a second blocking part 32 that is electrically connected to the second wireless circuit 31 are disposed on the second circuit board 30.

The first circuit board 20 and the second circuit board 30 are electrically connected to each other through an inter-board connection line 40.

The first connection part 11 is electrically connected to the first blocking part 22 on the first circuit board 20 through a first conductive element 23. Also, the second connection part 12 is electrically connected to the second blocking part 32 on the second circuit board 30 through a second conductive element 33.

In the above configuration, a description will be given in detail of a case in which, for example, the first wireless circuit 21 corresponds to Bluetooth (registered trademark) using 2.4 GHz band which is the first frequency band, and the second wireless circuit 31 corresponds to a GPS using 1.5 GHz band which is the second frequency band.

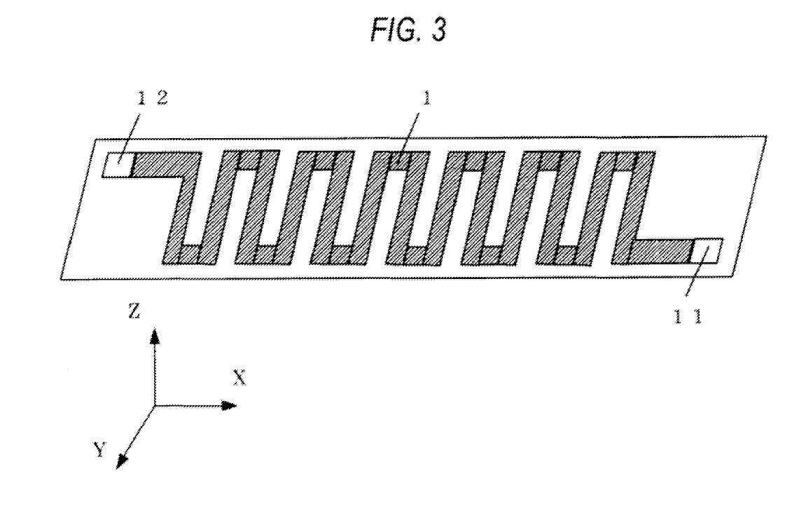

First, the configurations of the respective components will be described in detail. FIG. 3 is a diagram illustrating an example of a specific configuration of the antenna element 1 in the wireless communication terminal 200 according to this embodiment. The antenna element 1 is made of a conductor, and the first connection part 11 is disposed at one end of the antenna element 1. The first connection part 11 and the antenna element 1 are electrically connected to each other. Likewise, the second connection part 12 is disposed at the other end of the antenna element 1 at the side different from that of the first connection part 11. The second connection part 12 and the antenna element 1 are electrically connected to each other in the same manner.

With the above configuration, the respective wireless systems are connected to both ends of the antenna element 1 to enable communication.

In this embodiment, the first connection part 11 and the second connection part 12 are disposed at both ends of the antenna element 1. However, the present invention is not limited to this configuration. As the first connection part 11 and the second connection part 12 are wider, the antenna performances of those connection parts can be more increased. A sufficient advantage is obtained if the frequency band is 1/10 or more of the lower frequency band of the first frequency band and the second.

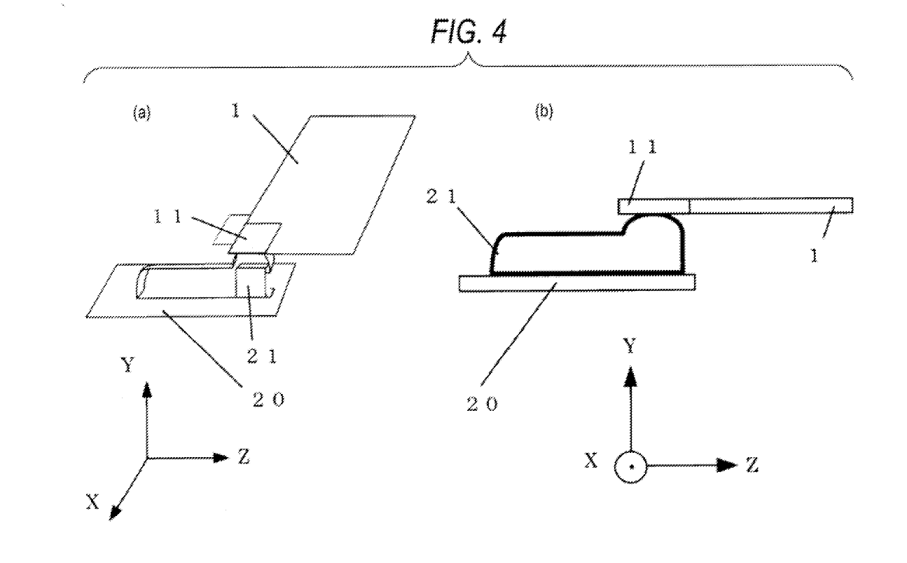

FIGS. 4(a) and 4(b) are diagrams illustrating an example of a specific configuration of the first conductive element 23 in the wireless communication terminal 200 according to this embodiment. FIG. 4(a) is a perspective view illustrating a layout relationship of components of the first conductive element 23, and FIG. 4(b) is a side view illustrating a connection relationship of components of the first conductive element 23. The first conductive element 23 is arranged on the first circuit board 20, and made of a conductor such as metal having a spring property.

With the above configuration, the first connection part 11 and the first circuit board 20 are connected to each other through the first conductive element 23 whereby the antenna element 1 and the first circuit board 20 are connected to each other in a high frequency manner.

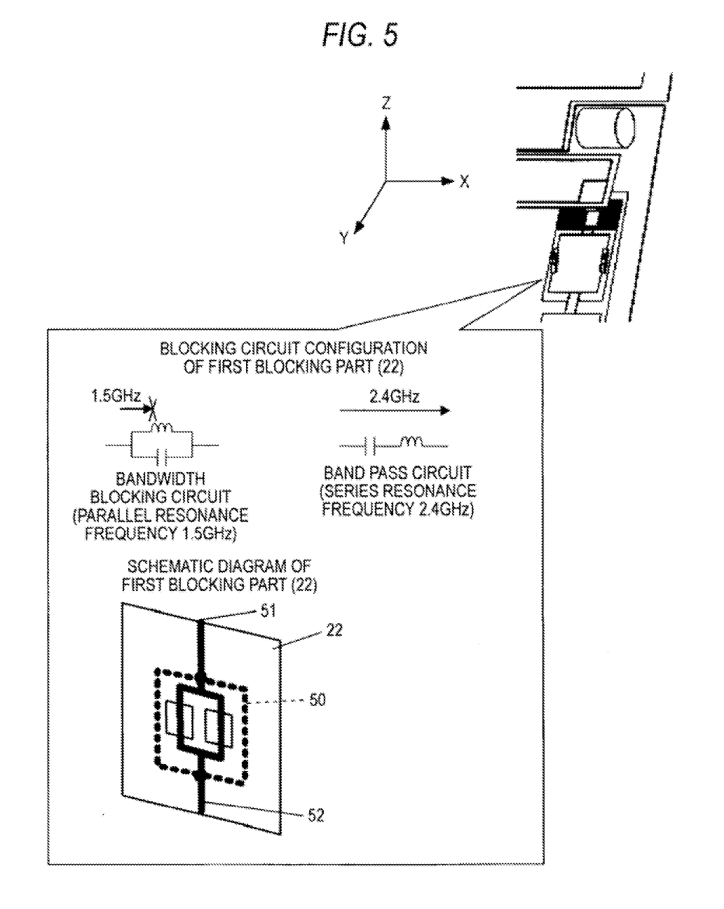

FIG. 5 is a diagram illustrating an example of a specific configuration of the first blocking part 22 in the wireless communication terminal 200 according to this embodiment. The first blocking part 22 is formed on the first circuit board 20. Also, the first blocking part 22 includes a first blocking circuit 50, a line 51 that electrically connects the first conductive element 23 to the first blocking circuit 50, and a line 53 that electrically connects the first blocking circuit 50 to the first wireless circuit 21 at a position different from that of the line 51.

The first blocking circuit 50 blocks 1.5 GHz band that is the second frequency band, and allows the passing of 2.4 GHz band which is the first frequency band. For example, the first blocking circuit 50 is configured by a band-pass circuit that allows the passing of 2.4 GHz (blocks 1.5 GHz band), or a bandwidth blocking circuit that blocks 1.5 GHz band (allows the passing of 2.4 GHz band).

With the above configuration, the first blocking part 22 can block 1.5 GHz band which is the second frequency band among flow-in high frequency currents, and can allow the passing of 2.4 GHz band which is the first frequency band.

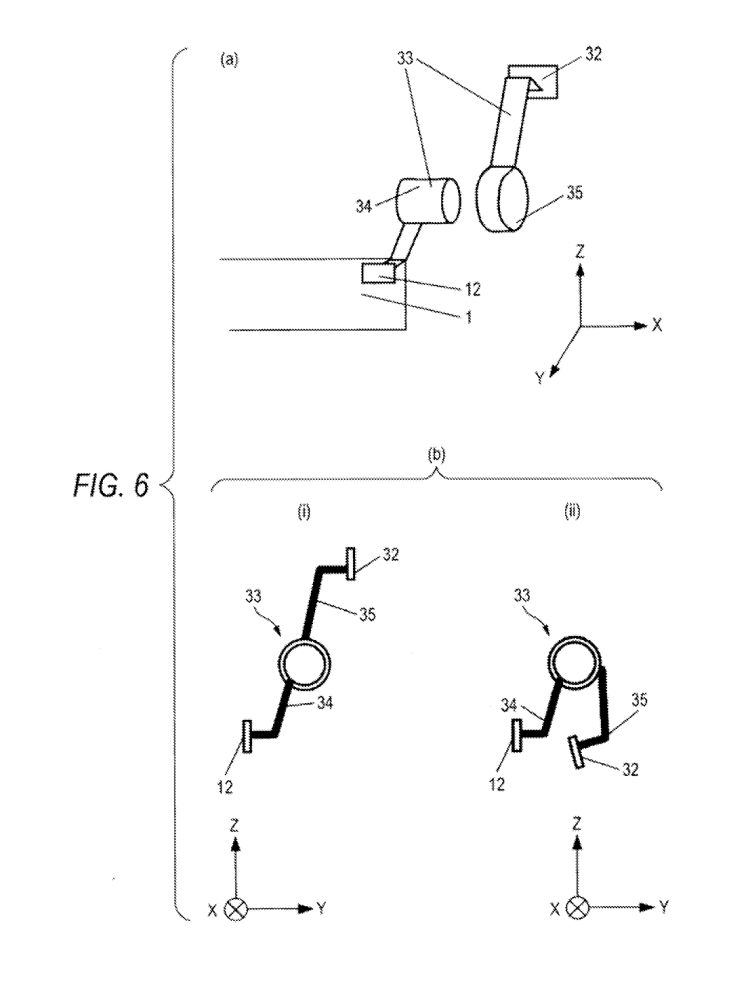

FIGS. 6(a) and 6(b) are diagrams illustrating an example of a specific configuration of the second conductive element 33 in the wireless communication terminal 200 according to this embodiment. FIG. 6(a) is a perspective view illustrating a layout relationship of components of the second conductive element 33, and FIG. 6(b) is a side view illustrating a connection relationship of components of the second conductive element 33. In this embodiment, the second conductive element 33 electrically connects the second blocking part 32 on the second circuit board 30 within the second housing 3 to the second connection part 12 connected to the antenna element 1 within the first housing 2, and must maintain the connection even when the housing is opened and closed. Hence, the second conductive element 33 according to this embodiment includes an antenna connection part 34 connected with the second connection part 12, and a second circuit board connection part 35 connected with the second blocking part 32 on the second circuit board 30, and the respective antenna connection part 34 and second circuit board connection part 35 maintain the electric connection while freely rotating according to the housing operation. The side view of FIG. 6(b) specifically illustrates the above configuration, and illustrates that the connection is maintained even in a state (i) where the housing is opened, and a state (ii) where the housing is closed.

With the above configuration, regardless of the open or close operation of the housing, the second connection part 12 is connected to the second blocking part 32 through the second conductive element 33 with the result that the antenna element 1 and the second circuit board 30 can be stably connected to each other in a high frequency manner.

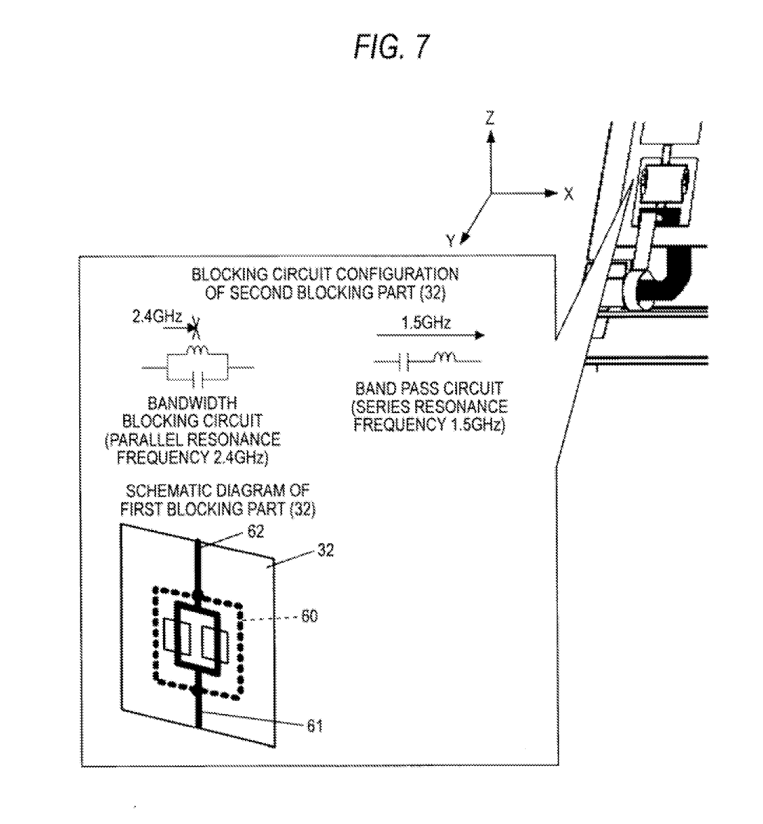

FIG. 7 is a diagram illustrating an example of a specific configuration of the second blocking part 32 in the wireless communication terminal 200 according to this embodiment. The second blocking part 32 is formed on the second circuit board 30. Also, the second blocking part 32 includes a second blocking circuit 60, a line 61 that electrically connects the second conductive element 33 to the second blocking circuit 60, and a line 62 that electrically connects the second blocking circuit 60 to the second wireless circuit 31 at a position different from that of the line 61.

The second blocking circuit 60 blocks 2.4 GHz band that is the first frequency band, and allows the passing of 1.5 GHz band which is the second frequency band. For example, the second blocking circuit 60 is configured by a band-pass circuit that allows the passing of the 1.5 GHz (blocks the 2.4 GHz band), or a bandwidth blocking circuit that blocks the 2.4 GHz band (allows the passing of the 1.5 GHz band).

With the above configuration, the second blocking part 32 can block the 2.4 GHz band which is the first frequency band among flow-in high frequency currents, and can allow the passing of the 1.5 GHz band which is the second frequency band.

Subsequently, the antenna operation of the respective wireless systems with the above configuration will be described.

In the 2.4 GHz band that is the first frequency band used by the first wireless circuit 21, a power (high frequency current) supplied from the first wireless circuit 21 flows in the first blocking part 22, the first conductive element 23, and the first connection part 11 without any loss, and is supplied to the antenna element 1. Also, because the second blocking part 32 blocks the 2.4 GHz band that is the first frequency band, no high frequency current flows from the antenna element 1 to the second blocking part 32.

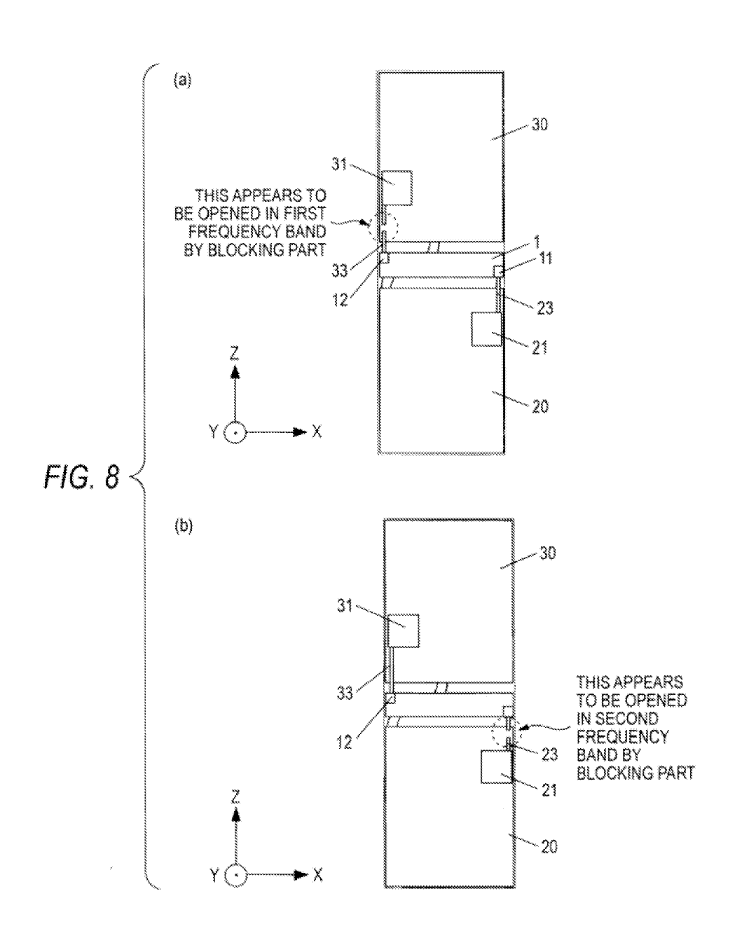

When the antenna element 1 and the second wireless circuit 31 are connected to each other through the second conductive element 33 in a state where there is no second blocking part 32, the power (high frequency current) supplied from the first wireless circuit 21 flows into the second wireless circuit 31 side, and is consumed. Therefore, the antenna performance and the isolation performance are deteriorated. On the contrary, as in this embodiment, the first wireless circuit 21 and the second wireless circuit 31 are disposed on boards different in potential, and the second blocking part 32 that blocks the first frequency band is provided. As a result, because the power (high frequency current) supplied from the first wireless circuit 21 flows in only the antenna element 1, it is possible to prevent the high frequency current from flowing into the second wireless circuit 31 through the antenna element 1. As described above, the antenna performance and the isolation performance which are excellent for the respective wireless systems can be ensured while feeding a power to one antenna element from the plurality of wireless systems. FIG. 8(a) schematically illustrates the above configuration.

Likewise, in the 1.5 GHz band that is the second frequency band used by the second wireless circuit 31, a power (high frequency current) supplied from the first wireless circuit 31 flows in the second blocking part 32, the second conductive element 33, and the second connection part 12 without any loss, and is supplied to the antenna element 1. Also, because the first blocking part 22 blocks the 1.5 GHz band that is the second frequency band, no high frequency current flows from the antenna element 1 to the first blocking part 22.

When the antenna element 1 and the first wireless circuit 21 are connected to each other through the first conductive element 23 in a state where there is no first blocking part 22, the power (high frequency current) supplied from the second wireless circuit 31 flows into the first wireless circuit 21 side, and is consumed. Therefore, the antenna performance and the isolation performance are deteriorated. On the contrary, as in this embodiment, the first wireless circuit 21 and the second wireless circuit 31 are disposed on the boards different in potential, and the first blocking part 22 that blocks the second frequency band is provided. As a result, because the power (high frequency current) supplied from the second wireless circuit 31 flows in only the antenna element 1, it is possible to prevent the high frequency current from flowing into the first wireless circuit 21 through the antenna element 1. As described above, the antenna performance and the isolation performance which are excellent for the respective wireless systems can be ensured while feeding a power to one antenna element from the plurality of wireless systems. FIG. 8(b) schematically illustrates the above configuration.

As described above, according to the wireless communication terminal 200 of this embodiment, one antenna element can accept the plurality of wireless systems different in the operating frequency, and the antenna performance excellent for the respective wireless systems can be obtained. Also, the wireless systems can operate at the same time, and the wireless communication terminal 200 that accepts the plurality of wireless systems can be downsized and thinned. In the above configuration, the GND patterns of the two circuit boards are connected by the inter-board connection line 40 (thin GND line for control line in the DC manner), the GND patterns have the same potential. However, in the high frequency manner, because of only the connection with the thin GND line, the potential is not the same, and it is assumed that the GND patterns are dealt with as the boards different in the potential.

Also, the antenna element 1 according to this embodiment assumes a folding structure, and in order to obtain the excellent isolation performance even if the housing is closed, the following configuration is assumed.

When the housing of the wireless communication terminal 200 illustrated in FIGS. 1(a) and 1(b) is closed, the first circuit board 20 having the first wireless circuit 21 and the second circuit board 30 having the second wireless circuit 31 come close to each other. Therefore, a capacitance is provided between the boards to perform the electromagnetic coupling. For that reason, the power supplied from the first wireless circuit 21 flows into the second circuit board 30, and is consumed by the second wireless circuit 31. Likewise, the power supplied from the second wireless circuit 31 flows into the first circuit board 20, and is consumed.

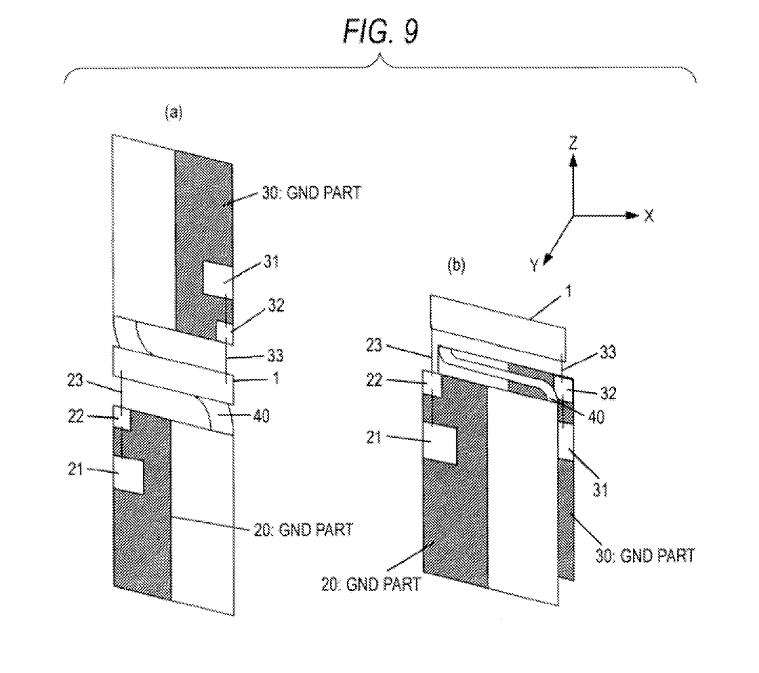

As described above, because the powers supplied from the wireless systems of the different boards flows in the respective boards, the antenna performance and the isolation performance are deteriorated. In order to solve the above problem, the wireless communication terminal 200 according to this embodiment is configured so that the respective circuit boards (GND patterns) are not overlapped with each other even if the housing is closed. FIGS. 9(a) and 9(b) schematically illustrate the above configuration. With the above configuration, the feed current is prevented from flowing through the GND patterns when the wireless systems are arranged on the same board. In addition, when the housing is closed, the GND pattern on the first circuit board 20 and the GND pattern on the second circuit board 30 come close to each other, and a capacitance is provided between the boards to perform the electromagnetic coupling, thereby preventing the antenna performance and the isolation performance from being deteriorated. In this way, it is possible to maintain the excellent performance even when the housing is closed.

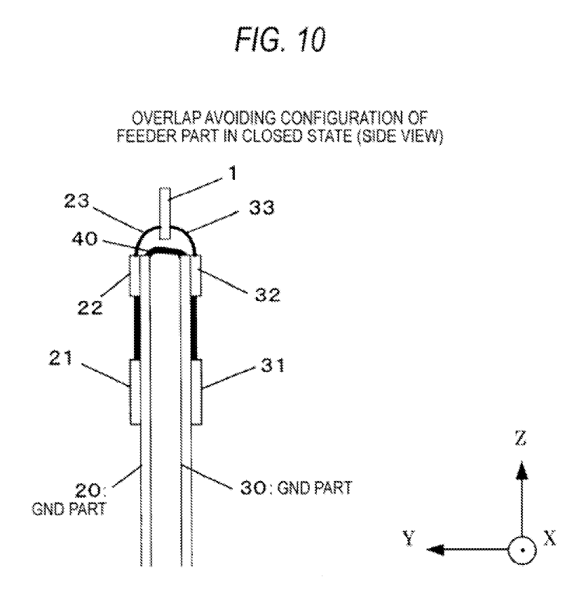

Also, as illustrated in FIG. 10, the configuration including the GND patterns are made so that a plane on which the first blocking part 22 and the first wireless circuit 21 are arranged does not overlap with a plane on which the second blocking part 32 and the second wireless circuit 31 are arranged even when the housing is closed. As a result, even when the housing is closed, the planes each having the GND pattern in which a current dominantly flows from the respective wireless systems do not overlap with each other, the electromagnetic coupling caused by disposing the GND patterns close to each other is suppressed, thereby enabling the isolation performance to be improved.

According to the wireless communication terminal 200 of this embodiment, one antenna element is used to accept the plurality of wireless systems different in the operating frequency, and the antenna performance excellent for the respective wireless systems can be obtained regardless of the open or close state of the housing. Also, because those wireless systems can operate at the same time, the wireless communication terminal 200 that accepts the plurality of wireless systems can be downsized and thinned.

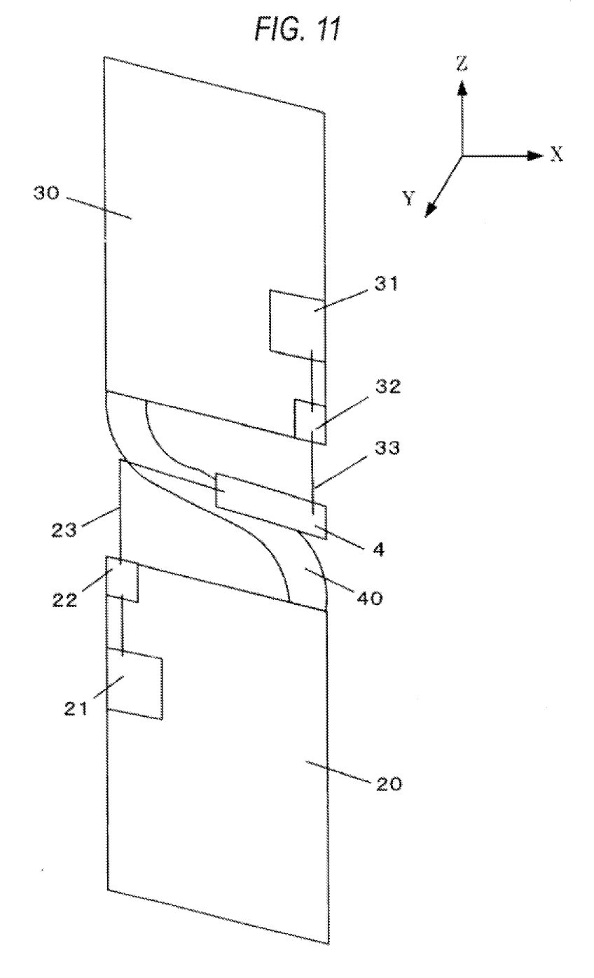

Also, as illustrated in FIG. 11, it is assumed that the hinge part 4 is used to configure the antenna, and the same advantages as those of the antenna element 1 are obtained. The hinge part 4 is movable and therefore made of a conductor such as metal. For that reason, the hinge part 4 can be used as the antenna. Under the circumstances, the first conductive element 23 and the second conductive element 33 are connected to the hinge part 4, and the existing parts are also used as the antenna element while obtaining the same advantages as those when the antenna element 1 is used. As a result, the terminal per se can be further downsized and thinned.

In this embodiment, the first frequency band is higher than the second frequency band, and an interval between the lowest frequency of the first frequency band and the highest frequency of the second frequency band is a fractional bandwidth 5% or higher to the center frequency of the first frequency band. With the above configuration, the first blocking part 22 can allow the passing of the first frequency band, and block the second frequency band. Likewise, the second blocking part 32 can allow the passing of the second frequency band, and block the first frequency band. Accordingly, the connection of the respective wireless systems to the antenna element 1 can be conducted in the frequency bands used by the wireless systems without any loss.

Also, in this embodiment, an example in which the first frequency band is the 2.4 GHz band, and the second frequency band is 1.5 GHz band is described. However, the present invention is not limited to those frequency bands, but it is assumed that the frequency bands accept various wireless systems.

Also, the respective drawings in this embodiment represent a coordinate system, and the positional relationship in each drawing is arranged on the basis of the coordinate system.

The present invention has been described in detail and with reference to a specific embodiment. However, it would be obvious to an ordinary skilled person that the present invention can be variously changed or corrected without departing from the spirit and scope of the present invention.

The present invention is based on Japanese Patent Application No. 2009-276293 filed on Dec. 4, 2009, and the contents of which are incorporated herein by reference.

### INDUSTRIAL APPLICABILITY

The wireless communication terminal according to the present invention has such advantages that one antenna element is used to accept the plurality of wireless systems different in the operating frequency, and the antenna performance excellent for the respective wireless systems can be obtained. The present invention can be applied to the thinned and downsized wireless communication terminal in which the plurality, of wireless systems is mounted.

### DESCRIPTION OF REFERENCE SYMBOLS

1, antenna element
2, first housing
3, second housing
4, hinge part
11, first connection part
12, second connection part
20, first circuit board
21, first wireless circuit
22, first blocking part
23, first conductive element
30, second circuit board
31, second wireless circuit
32, second blocking part
33, second conductive element
34, antenna connection part
35, second circuit board connection part
40, inter-board connection line
50, first blocking circuit
51, 52, line of first blocking part
60, second blocking circuit
61, 62, line of second blocking part
71, first antenna element of Patent Document 1
72, second antenna element of Patent Document 1
81, first antenna element of Patent Document 2
82, second antenna element of Patent Document 2
83, slit of Patent Document 2
84, first feeder part of Patent Document 2
85, second feeder part of Patent Document 2
91, antenna element of Patent Document 3
92, bandwidth changeover switch of Patent Document 3
200, wireless communication terminal

1. A wireless communication terminal having a plurality of wireless systems different in operating frequencies, and having a hinge part which rotatably couples a first housing with a second housing, the wireless communication terminal comprising:
a first wireless circuit having a first frequency band as the operating frequency;
a second wireless circuit having a second frequency band different from the first frequency band as the operating frequency;
a first circuit board disposed in the first housing and having the first wireless circuit mounted therein;
a second circuit board disposed in the second housing and having the second wireless circuit mounted therein;
an inter-board connection line that connects the first circuit board and the second circuit board for control the first circuit board and the second circuit board;
an antenna element disposed at a given distance from the first circuit board;
a first connection part electrically connected to the antenna element;
a second connection part electrically connected to the antenna element at a position different from that of the first connection part;
a first conductive element electrically connected to the first connection part;
a first blocking part electrically connected to the first conductive element and the first wireless circuit, disposed on the first circuit board, and blocks the second frequency band;
a second conductive element electrically connected to the second connection part; and
a second blocking part electrically connected to the second conductive element and the second wireless circuit, disposed on the second circuit board, and blocks the second frequency band.

2. The wireless communication terminal according to claim 1, wherein the first connection part and the second connection part which are electrically connected to the antenna element are formed at both ends of the antenna element in a longitudinal direction of the antenna element.

3. The wireless communication terminal according to claim 1, wherein a GND pattern provided on the first circuit board and a GND pattern provided on the second circuit board are configured at positions that do not overlap with each other when the housings are closed.

4. The wireless communication terminal according to claim 1, wherein the first blocking part provided in the first circuit board and the second blocking part provided in the second circuit board are configured on surfaces that do not overlap with each other when the housings are closed.

5. The wireless communication terminal according to claim 1, wherein the hinge part is configured by the antenna element.
